(19) United States
(12) Patent Application Publication
(10) Pub. No.: US 2022/0222544 A1
(43) Pub. Date: Jul. 14, 2022

(54) ANALYSIS DEVICE, ANALYSIS METHOD, AND ANALYSIS PROGRAM

(71) Applicant: NIPPON TELEGRAPH AND TELEPHONE CORPORATION, Tokyo (JP)

(72) Inventors: Tetsuya SHIODA, Musashino-shi, Tokyo (JP); Miki SAKAI, Musashino-shi, Tokyo (JP); Masakuni ISHII, Musashino-shi, Tokyo (JP); Kazuki OIKAWA, Musashino-shi, Tokyo (JP)

(73) Assignee: NIPPON TELEGRAPH AND TELEPHONE CORPORATION, Tokyo (JP)

(21) Appl. No.: 17/607,421

(22) PCT Filed: May 9, 2019
(86) PCT No.: PCT/JP2019/018637

§ 371 Date: Oct. 29, 2021

(51) Int. Cl. G06N 5/02; G06N 5/04

(52) U.S. Cl. CPC G06N 5/022; G06N 5/04

(57) ABSTRACT

A generating unit generates data with pseudo-correct answers by labeling unlabeled data with no correct answers on the basis of labeled data with correct answers using a plurality of prediction models for predicting a label from data, the prediction models being built according to different building procedures from one another. A calculating unit calculates the prediction accuracy of each of the prediction models using the data with correct answers and the data with the pseudo-correct answers. A determining unit determines a prediction model with a prediction accuracy calculated by the calculating unit satisfying a prescribed criterion.

### TECHNICAL FIELD

The present invention relates to an analysis device, an analysis method, and an analysis program.

### BACKGROUND ART

In recent years, machine learning has been applied to an increased number of data analysis cases. Meanwhile, medium to long term education is required to acquire knowledge of statistics and machine learning which is essential for data analysis. Some documents describe techniques for aiding non-specialists to easily engage in data analysis without having to acquire such knowledge of statistics and machine learning.

For example, a known method uses a sequential model-based optimization (SMBO) to evaluate accuracy for each pipeline and search for an optimum pipeline (see, for example NPL 1 and NPL 2). Here, the pipeline refers to a series of processing steps for building a prediction model and includes preprocessing to input data and data learning on the basis of hyperparameters. According to another known method, among a large number of pipelines predesigned by experts, a small number of pipelines adapted to analysis target data are presented to a user.

### CITATION LIST

### Non Patent Literature

[NPL 1] Matthias Feurer, Aaron Klein, Katharina Eggensperger, Jost Tobias Springenberg, Manuel Blum, Frank Hutter, “Efficient and Robust Automated Machine Learning,” NIPS'15 Proceedings of the 28th International Conference on Neural Information Processing System, December, 2015, PP. 2755-2763

[NPL 2] Lisha Li, Kevin Jamieson, Giulia DeSalvo, Afshin Rostamizadeh, Ameet Talwalkar, “Hyperband: A Novel Bandit-Based Approach to Hyperparameter Optimization,” arXiv: 1603.06560v3, cs.LG, November, 2016

### SUMMARY OF THE INVENTION

### Technical Problem

However, the conventional method for automating data analysis does not allow data with no correct answers to be effectively used to improve the accuracy of the prediction model. Here, semi-supervised learning has been known to improve prediction model accuracy using data with no correct answers which is easier to collect than data with correct answers. Meanwhile, according to the conventional approaches, it is assumed that prediction models are built using only data with correct answers, and semi-supervised learning is not taken into account.

### Means for Solving the Problem

The analysis device according to the present invention includes a generating unit which generates data with a pseudo-correct answer by labeling unlabeled second data on the basis of labeled first data using a plurality of prediction models for predicting a label from data, the prediction models being built according to different building procedures from one another, a calculating unit which calculates a prediction accuracy for each of the prediction models using the first data and the data with the pseudo-correct answer, and a determining unit which determines a prediction model with a prediction accuracy calculated by the calculating unit satisfying a prescribed criterion.

### Effects of the Invention

According to the present invention, data with no correct answers can be effectively utilized to improve the accuracy of the prediction model.

### BRIEF DESCRIPTION OF THE DRAWINGS

FIG. 1 is a diagram for illustrating an outline of processing for determining a pipeline candidate.

FIG. 2 is a diagram of an exemplary configuration of an analysis device according to a first embodiment of the invention.

FIG. 3 is a table of an exemplary data configuration of setting information.

FIG. 4 is a table of an exemplary data configuration of predictor information.

FIG. 5 is a diagram for illustrating cross-validation.

FIG. 6 is a diagram of exemplary pipeline candidates.

FIG. 7 is a diagram for illustrating how a pipeline is determined when semi-supervised learning is performed.

FIG. 8 is a diagram for illustrating how a pipeline is determined for each evaluation value.

FIG. 9 is a diagram for illustrating validation of a prediction model.

FIG. 10 is a flowchart for illustrating the flow of processing by the analysis device according to the first embodiment.

FIG. 11 is a flowchart for illustrating the flow of processing for determining a pipeline candidate.

FIG. 12 is a flowchart for illustrating the flow of processing for determining a pipeline.

FIG. 13 is a flowchart for illustrating the flow of label spreading.

FIG. 14 is a flowchart for illustrating the flow of self-training.

FIG. 15 is a diagram of an exemplary computer which executes an analysis program.

### DESCRIPTION OF EMBODIMENTS

Hereinafter, embodiments of the present invention will be described in detail with reference to the drawings. The present invention is not limited by the embodiment. In the drawings, the same portions are designated by the same reference characters.

### Summary of First Embodiment

An analysis device according to a first embodiment of the invention is a device for aiding data analysis by machine learning. Here, when data analysis is performed by machine learning, a pipeline as a series of processing steps for building a prediction model is determined.

The analysis device first determines pipeline candidates by preparing a choice of setting content candidates for each of a plurality of setting items related to a prediction model and sequentially determining setting contents from the choice. The analysis device then determines a pipeline suitable for semi-supervised learning among the candidates. Note that the analysis device may ultimately determine one or more pipelines.

In this example, the pipeline is a procedure for building a prediction model. Data with correct answers is for example labeled data. Also, data with no correct answer is for example unlabeled data.

[Processing for Determining Pipeline Candidates]

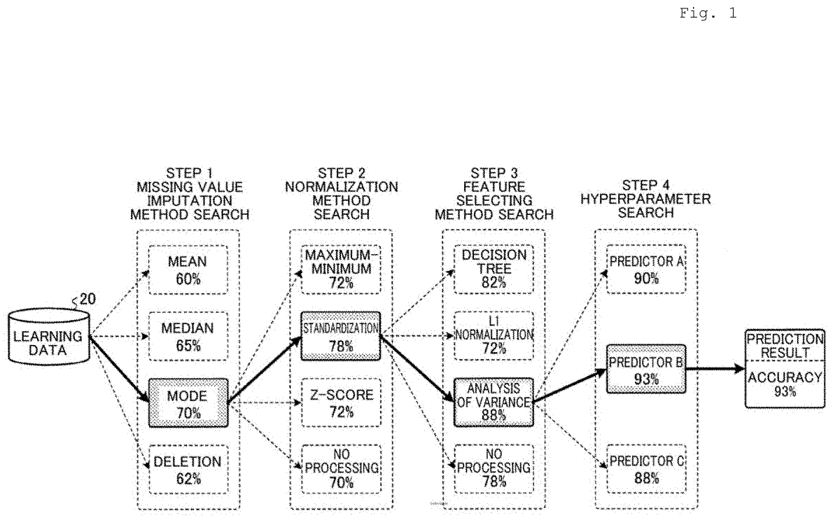

The processing for determining pipeline candidates will be described. FIG. 1 is a diagram of an outline of processing for determining a pipeline candidate. As shown in FIG. 1, the analysis device 10 sequentially executes steps corresponding to a plurality of processing steps executed in building a prediction model to determine setting contents for each setting item. For example, the analysis device 10 determines, in the steps, a method used in preprocessing, a predictor algorithm, and hyperparameters.

For example, in step 1, the analysis device 10 determines a method used in missing value imputation as one kind of the preprocessing among the mean, the median, the mode, and the deletion. At the time, the analysis device 10 calculates the prediction accuracy of a prediction model to be built for each of the methods using the mean, the median, the mode, and the deletion for missing value imputation in the learning data 20 and determines the method with the highest prediction accuracy for the prediction model as the missing value imputation method. In the example shown in FIG. 1, the prediction accuracy is 60% with the mean, 65% with the median, 70% with the mode, and 62% with the deletion and the highest prediction accuracy is obtained with the mode, so that the analysis device 10 determines the method with the mode for missing value imputation.

Similarly, in step 2, the analysis device 10 determines a method used in normalization as one kind of the pre-processing among maximum-minimum, standardizing, Z-score, and non-processing. The non-processing means that the pre-processing is not performed. In step 3, the analysis device 10 determines a method used in feature selection as one kind of the preprocessing among decision trees, L1 normalization, analysis of variance, and non-processing.

In step 4, the analysis device 10 determines, as a predictor to be used in the prediction model, a predictor B with the highest accuracy for the prediction model to be built among a predictor A, a predictor B, and a predictor C. It is assumed that the predictor A, the predictor B, and the predictor C have different algorithms. The analysis device 10 also determines hyperparameters for each of the predictors in step 4.

As a result, a pipeline determined by the analysis device 10 performs missing value imputation using the mode, normalization using standardization, and feature selection using analysis of variance, and the predictor B is used as the predictor. In each step, the analysis device 10 may learn on the basis of a part of data and calculate the prediction accuracy while performing cross-validation to validate the prediction accuracy of the prediction model with the remaining data.

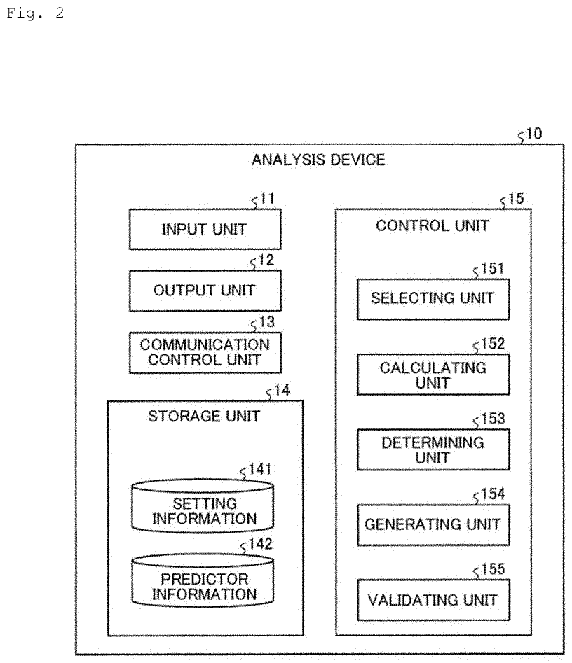

Next, the configuration of the analysis device 10 will be described with reference to FIG. 2. FIG. 2 is a diagram of an exemplary configuration of the analysis device according to the first embodiment. As shown in FIG. 2, the analysis device 10 is implemented by a workstation and a general purpose computer such as a personal computer and includes an input unit 11, an output unit 12, a communication control unit 13, a storage unit 14, and a control unit 15.

The input unit 11 is implemented using an input device such as a keyboard or a mouse device, and inputs various kinds of instruction information to the control unit 15 in response to an input operation by an operator. The output unit 12 is implemented for example by a display device such as a liquid crystal display, a printing device such as a printer, and an information communication device and outputs for example a result of data analysis to the operator.

The communication control unit 13 is implemented for example by an NIC (Network Interface Card) and controls communication between an external device such as a management server and the control unit 15 over a telecommunication line such as a LAN (Local Area Network) and the Internet.

The storage unit 14 is implemented by a semiconductor memory device such as a RAM (Random Access Memory) and a Flash memory or a storage device such as a hard disk and an optical disk. The storage unit 14 stores a processing program which causes the analysis device 10 to operate or data to be used during execution of the processing program previously or each time processing is performed. The storage unit 14 may configured to communicate with the control unit 15 through the communication control unit 13. The storage unit 14 stores setting information 141 and predictor information 142.

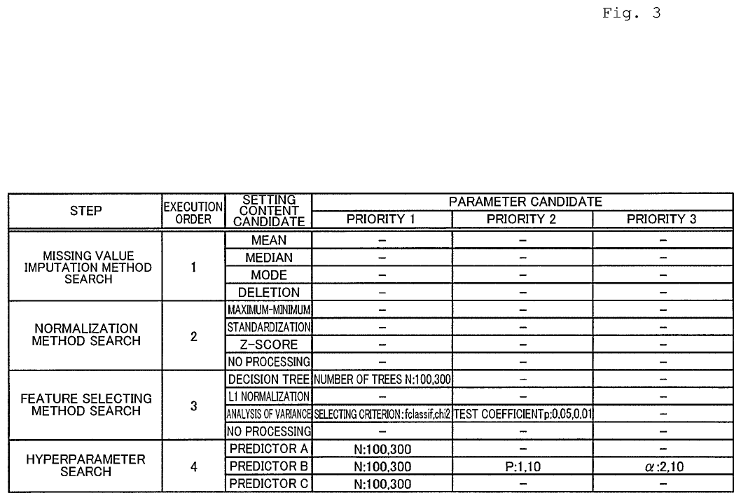

Here, the setting information 141 will be described with reference to FIG. 3. FIG. 3 is a diagram of an exemplary data configuration of the setting information. As shown in FIG. 3, the setting information 141 includes a step-by-step execution sequence, setting content candidates, and parameter candidates. The setting content candidates are candidates of setting items corresponding to respective steps. The parameter candidates are candidates of parameters which can be set to the selected setting content.

In the example in FIG. 3, the setting information 141 indicates, as steps, “missing value imputation method search,” “normalization method search,” “feature selecting method search” and “hyperparameter search.” These steps correspond to steps 1 to 4 in FIG. 1.

In the example in FIG. 3, the setting information 141 indicates that the “feature selecting method search” is the third step to be performed. The setting information 141 indicates that “decision tree,” “L1 normalization,” “analysis of variance,” and “no processing” are setting content candidates for the setting item corresponding to the step “feature selecting method search.” In the example in FIG. 3, the setting item corresponding to the step “feature selecting method search” is a method used in feature selection. The setting information 141 indicates that 100 and 300 are candidates for the number of trees N as a parameter for the setting content candidate “decision tree.” Priorities are set for parameter candidates.

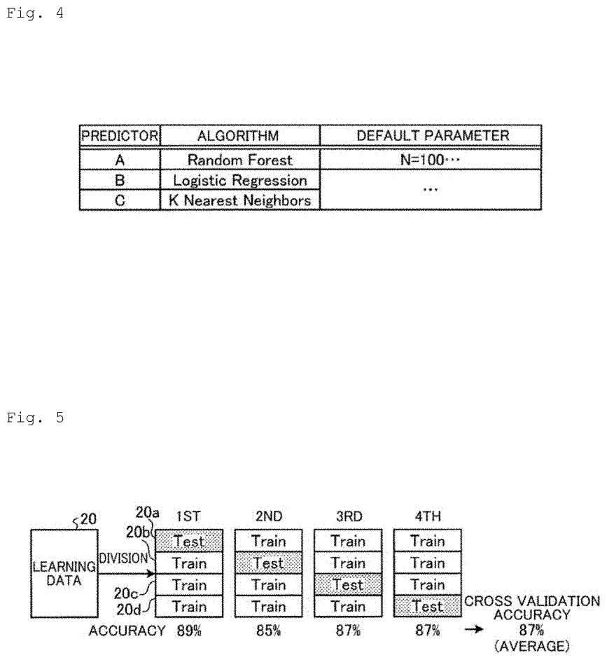

The predictor information 142 will be described with reference to FIG. 4. FIG. 4 is a diagram of an exemplary data configuration of the predictor information. As shown in FIG. 4, the predictor information 142 includes an algorithm and a default parameter for each predictor. As for the algorithms used in the predictors as shown in FIG. 4 may include “Random Forest,” “Logistic Regression,” and “K Nearest Neighbors.” The default parameter is a parameter default value for each of the algorithms. The default parameter includes a hyperparameter default value for a predictor. For example, the predictor information 142 indicates that the default value for the parameter N for the algorithm “Random forest” for the predictor A is 100.

The control unit 15 functions as a selecting unit 151, a calculating unit 152, a determining unit 153, a generating unit 154, and a validating unit 155 as shown in FIG. 2 as an arithmetic processing device such as a CPU (Central Processing Unit) executes the processing program stored in the memory. All or some of these functional units maybe implemented in different kinds of hardware.

The selecting unit 151 selects the next step to be executed each time a setting content is determined in any of steps corresponding to each of a plurality of kinds of processing to be executed in building a prediction model or each of pipelines for sequentially determining a setting content for the corresponding processing. The determining unit 153 determines a setting content for each step among the setting content candidates included in the setting information 141. At the time, the selecting unit 151 selects the next step having its setting content determined according to the execution order indicated in the setting information 141. When none of the steps is executed, the selecting unit 151 selects the earliest step in the execution order.

For example, as shown in FIG. 3, the next step to the step “normalization method search” is the “feature selecting method search,” and therefore, when the setting content for the step “normalization method search” is determined, the selecting unit 151 selects “feature selecting method search” as the next step.

The steps of “missing value imputation method search,” “normalization method search” and “feature selecting method search” in FIG. 3 are pre-processing determination steps for determining a setting content for missing value imputation, normalization, and feature selection, respectively as pre-processing for learning and analysis data. The setting content candidates for the steps of “missing value imputation method search,” “normalization method search,” and “feature selecting method search” are methods used in missing value imputation, normalization, and feature selection, respectively. The step “hyperparameter search” is executed after the preprocessing determination steps and is a predictor determining step for determining an algorithm and a hyperparameter for the predictor as a setting content.

The calculating unit 152 performs processing having its setting content determined among the plurality of kinds of processing by applying the determined setting content and calculates a prediction accuracy for each of prediction models built when processing corresponding to the step selected by the selecting unit 151 is performed by applying the setting content candidates.

For example, when the selecting unit 151 selects the step “feature selecting method search,” prediction models may be built by applying setting contents determined in the steps of “missing value imputation method search” and “normalization method search” since the setting contents for the “missing value imputation method search” and the “normalization method search” have already been determined and the setting content candidates for the step “feature selecting method search.” At the time, since there are four setting content candidates for the step “feature selecting method search,” when the setting contents for the steps of “missing value imputation method search” and “normalization method search” are each determined as one content, at least four prediction models can be built.

The calculating unit 152 calculates a prediction accuracy for each of buildable prediction models. At the time, the setting contents for the steps of “missing value imputation method search” and “normalization method search” may be determined in a plurality of manners. For example, when two setting contents are determined for each of the steps of “missing value imputation method search” and “normalization method search,” the number of buildable prediction models is at least eight.

Alternatively, when for example the selecting unit 151 selects the step “hyperparameter search,” prediction models may be built by applying the setting contents determined for the steps of “missing value imputation method search,” “normalized method search,” and “feature selecting method search” and setting content candidates for the “hyperparameter search,” since the setting contents for the steps of “missing value imputation method search,” the “normalization method search,” and the “feature selecting method search” precede the step “hyperparameter search” in the execution order and have their setting contents already determined. The calculating unit 152 calculates a prediction accuracy for each of the buildable prediction models.

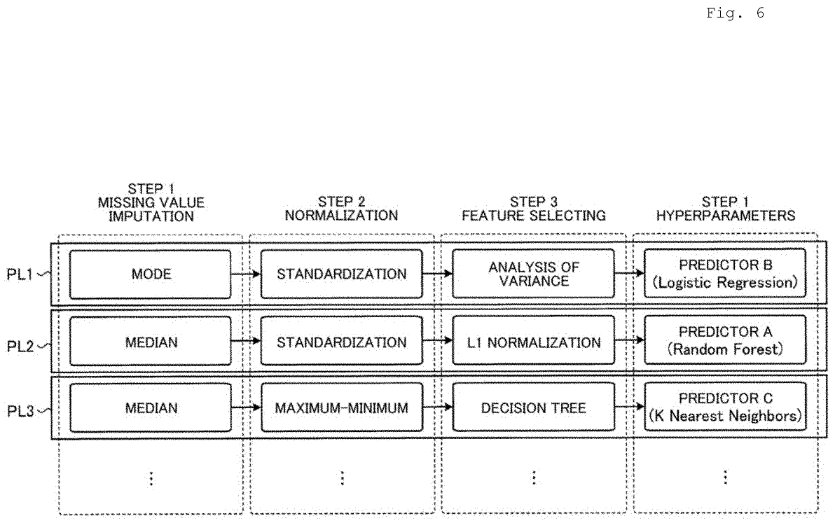

The calculating unit 152 can calculate the prediction accuracy by performing cross validation using learning data divided into a predetermined number. Here, the cross validation will be described with reference to FIG. 5. FIG. 5 is a diagram for illustrating the cross-validation.

As shown in FIG. 5, the calculating unit 152 divides the learning data 20 into four parts, learning data pieces 20a, 20b, 20c, and 20d. The calculating unit 152 has a predictor learn the learning data pieces 20b, 20c, and 20d using a prediction model as the first processing and measures the accuracy of the predictor having learned using the learning data piece 20a.

Similarly, as the second processing, the calculating unit 152 has the predictor learn the learning data pieces 20a, 20c, and 20d and measures the accuracy of the predictor having learned using the learning data piece 20b. As the third processing, the calculating unit 152 has the predictor learn the learning data pieces 20a, 20b, and 20d, and measures the accuracy of the predictor having learned using the learning data piece 20c. As the fourth processing, the calculating unit 152 has the predictor learn the learning data pieces 20a, 20b, and 20c and measures the accuracy of the predictor having learned using the learning data piece 20d. Then, the calculating unit 152 determines a cross-validation accuracy obtained as the average of the accuracies measured by the four processing occasions as a prediction accuracy. Note that the division number in the cross-validation is not limited to 4 and can be any number.

The calculating unit 152 can calculate prediction accuracies using the plurality of predictor candidates. For example, as shown in FIG. 3, in the steps preceding to the step “hyperparameter search,” the predictor to be used in the prediction model is not determined, and therefore in the steps of “missing value imputation method search” “normalization method search,” and “feature selecting method search,” the calculating unit 152 calculates prediction accuracies respectively using the predictor A, the predictor B, and the predictor C. For example, when the selecting unit 151 has selected the step “feature selecting method search” and determined one setting content for each of the steps of “missing value imputation method search” and “normalization method search,” there are four setting content candidates for the step “feature selecting method search,” and there are three predictor candidates, so that the calculating unit 152 calculates prediction accuracies for at least 12 prediction models.

The determining unit 153 compares the prediction accuracies calculated by the calculating unit 152 and determines the setting content candidate with the highest prediction accuracy among the setting content candidates as the setting content corresponding to the step selected by the selecting unit 151.

For example, as shown in FIG. 1, in the step “normalization method search,” the calculating unit 152 calculates the prediction accuracy of a prediction model corresponding to the setting content “maximum minimum” as 72%, the prediction accuracy of the prediction model corresponding to the setting content “standardization” as 78%, the prediction accuracy of a prediction model corresponding to the setting content “Z score” as 72%, the prediction accuracy of a prediction model corresponding to the setting content “non-processing” as 70%. At the time, since the prediction model with the highest prediction accuracy in the step “normalization method search” is a prediction model corresponding to the setting content “standardization,” the determining unit 153 determines the setting content for the setting item corresponding to the step “normalization method search” as “standardization.” More specifically, the determining unit 153 determines the standardization as the method used in the normalization which is carried out as data preprocessing.

As described above, the selecting unit 151 selects the next step to be executed after the step having its setting content determined by the determining unit 153. For example, when the setting content in the step “normalization method search” is determined by the determining unit 153, the selecting unit 151 selects the step “feature selecting method search.”

Finally, when the selecting unit 151 selects the step “hyper parameter search,” the calculating unit 152 calculates the prediction accuracy for each of the setting contents in the step, and the determining unit 153 determines the setting content with the highest prediction accuracy, pipelines as procedures for building a prediction model from step 1 to step 4 are determined.

Here, the analysis device 10 determines a plurality of pipelines as candidates in a similar manner. For example, the analysis device 10 may determine a predetermined number of pipelines as candidates in the descending order of prediction accuracies in the final step (for example step 4), or all pipelines with a prediction accuracy above a threshold value in the final step may be selected as candidates. The method for determining pipeline candidates described above is exemplary, and the analysis device 10 may determine the pipelines in any other way.

[Processing for Determining Pipeline]

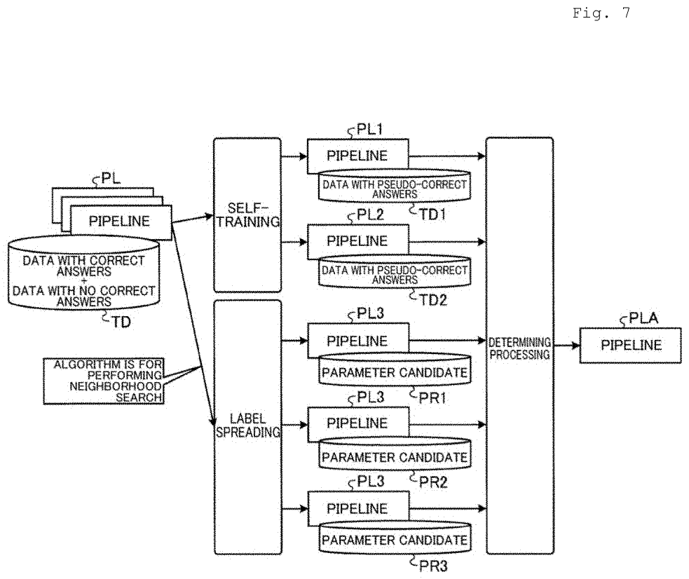

The processing for finally determining a pipeline among the pipeline candidates will be described. At the time point, pipeline candidates have been determined as shown in FIG. 6. FIG. 6 is a diagram for illustrating exemplary pipeline candidates.

For example, a pipeline PL1 includes a series of processing steps such as missing value imputation by mod, normalization by standardization, feature selection by analysis of variance, and label prediction by the predictor B. A pipeline PL2 includes a series of processing steps such as missing value imputation by median, normalization by standardization, feature selection by L1 normalization, and label prediction by the predictor A. A pipeline PL3 includes a series of processing steps such as missing value imputation by median, normalization by maximum-minimum, feature selection by decision tree, and label prediction by the predictor C.

The algorithm of the predictor A is Logistic Regression. The algorithm of the predictor B is Random Forest. The algorithm of the predictor C is K Nearest Neighbors. Among these algorithms, K Nearest Neighbors is an algorithm for neighborhood search.

FIG. 8 is a diagram for illustrating how a pipeline is determined when semi-supervised learning is performed. Here, it is assumed that data with no correct answers is provided separately from the learning data 20. The learning data 20 is data with correct answers. The data with correct answers and the data with no correct answers are put together as TD. A pipeline candidate is designated by PL.

Here, the generating unit 154 generates data with pseudo-correct answers by labeling unlabeled data with no correct answers on the basis of labeled data with correct answers using a plurality of prediction models for predicting a label from data and built in a plurality of building procedures different from one another.

Specifically, the generating unit 154 performs self-training or label spreading for each of the pipelines included in the pipeline candidates PL and labels the data with no correct answers. When the algorithm of the predictor is neighborhood search, the generating unit 154 performs label spreading. Meanwhile, when the algorithm of the predictor is not neighborhood search, the generating unit 154 performs self-training.

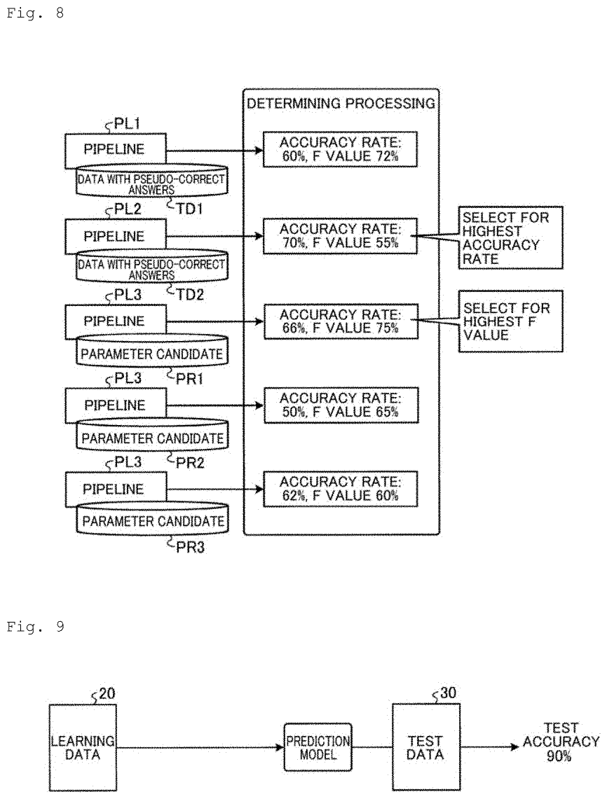

During the self-training, the generating unit 154 generates data with pseudo correct answers for each of the pipelines. The data with pseudo-correct answers is obtained by providing data with no correct answers with a label predicted by the prediction model. For example, in the example in FIG. 7, the generating unit 154 generates data with pseudo-correct answers TD1 for the pipeline PL1. The generating unit 154 generates data with pseudo-correct answers TD2 for the pipeline PL2.

In the self-training, the generating unit 154 repeats first processing for building a prediction model using building data including data with correct answers and second processing for labeling data for which the certainty of a label predicted using the prediction model built in the first processing is at least equal to a threshold among data with no correct answers and then adding the labeled data to the building data. In the second processing, the data added to the building data is the data with pseudo-correct answers.

When the prediction model is for performing neighborhood search, the generating unit 154 performs label spreading for the data with no correct answers on the basis of the data with correct answers by neighborhood search for which each of the plurality of parameter candidates is set. When the label spreading is performed, the generating unit 154 adds a parameter candidate for neighborhood search to a pipeline. A parameter candidate for neighborhood search is for example the value k in K Nearest Neighbors.

For example, in the example in FIG. 7, the generating unit 154 adds a parameter candidate PR1, a parameter candidate PR2, and a parameter candidate PR3 to pipelines PL3. The pipelines with the additional parameter candidates are treated as different pipelines in subsequent processing.

The calculating unit 152 calculates the prediction accuracies of prediction models using data with correct answers and data with pseudo-correct answers. When label spreading is performed, the calculating unit 152 calculates the prediction accuracies of the prediction models for each of parameter candidates using data with correct answers and label-spread data with no correct answers.

As shown in FIG. 7, the determining unit 153 performs determination processing for determining a prediction model for which the prediction accuracy calculated by the calculating unit 152 satisfies a predetermined criterion. In the example in FIG. 8, the determining unit 153 determines any of the pipeline PL1, the pipeline PL2, the pipeline PL3+PR1, the pipeline PL3+PR2, and the pipeline PL3+PR3 as the optimum pipeline PLA. The determining processing may also be performed by cross-validation.

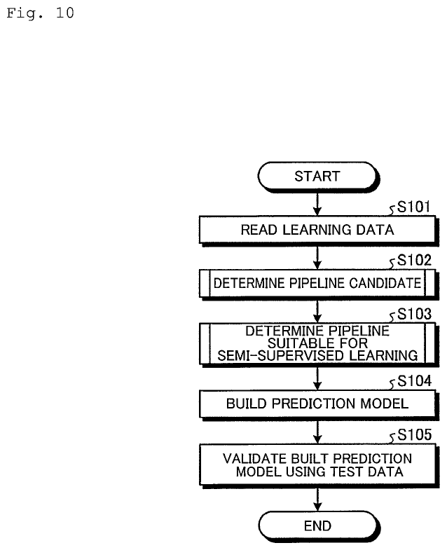

As shown in FIG. 9, the calculating unit 152 can express the calculated prediction accuracy in a plurality of indices. In the example in FIG. 9, the prediction accuracy is expressed as an accuracy rate and an F value. At the time, the determining unit 153 determines a prediction model in which any of the plurality of indices becomes optimum among the building procedures. For example, the determining unit 153 determines the pipeline PL2 with the highest accuracy rate and the pipeline PL3+PR1 with the highest F value.

The validating unit 155 validates the prediction model and the corresponding pipelines determined by the determining unit 153. FIG. 9 is a diagram for illustrating how the prediction model is validated. As shown in FIG. 9, when the prediction model is determined by the determining unit 153, the validating unit 155 has the predictor learn the learning data 20 on the basis of the pipelines. The validating unit 155 measures the prediction accuracy of the built prediction model as a test accuracy using test data 30 which is different from the learning data 20. The analysis device 10 may provide the test accuracy measured in this way as a final output. The validation using the test data 30 different from the learning data 20 allows an over-learning state and a non-learning state to be checked. The learning data includes data with pseudo correct answers as well as data with correct answers.

### Processing According to First Embodiment

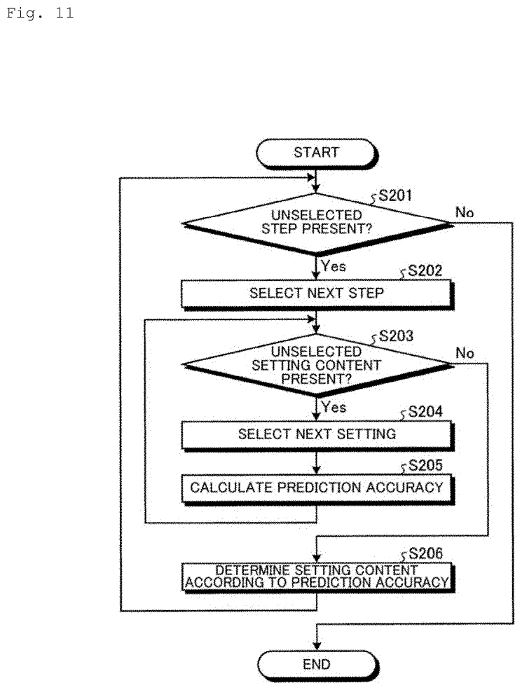

With reference to FIG. 10, the flow of processing by the analysis device 10 according to the first embodiment will be described. FIG. 10 is a flowchart for illustrating the flow of processing by the analysis device according to the first embodiment. As shown in FIG. 10, the analysis device 10 first reads the learning data 20 (step S101). Then, the analysis device 10 determines pipeline candidates using the read learning data 20 (step S102). The analysis device 10 then determines a pipeline suitable for semi-supervised learning (step S103). Here, the validating unit 155 of the analysis device 10 builds a prediction model on the basis of the determined pipeline (step S104) and validates the built prediction model using the test data 30 (step S105).

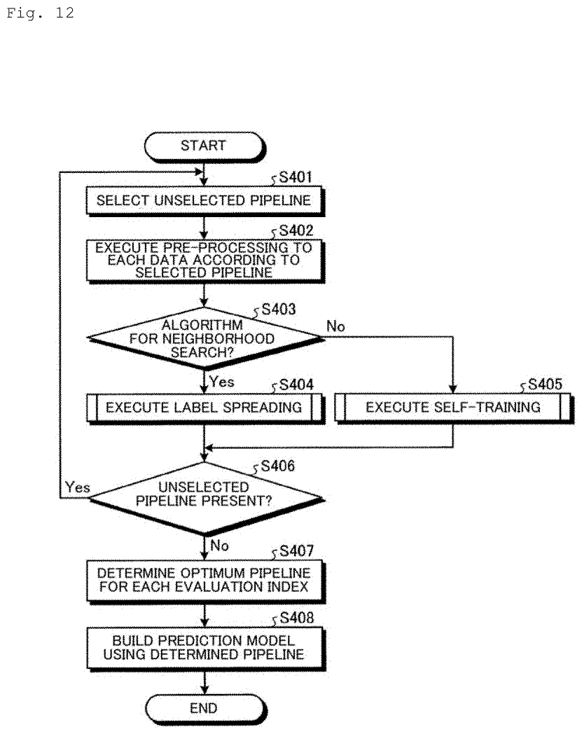

With reference to FIG. 11, the processing for determining pipeline candidates (step S102 in FIG. 10) by the analysis device 10 will be described in detail. As shown in FIG. 11, when there is an unselected step (Yes in step S201), the selecting unit 151 selects the next step by referring to the setting information 141 (step S202). The next step is the earliest step in the execution order among the unselected steps. Meanwhile, when there are no unselected steps (No in step S201) , the analysis device 10 ends the processing for determining pipelines.

When there is an unselected setting content in the setting content candidates for the step selected by the selecting unit 151 (Yes in step S203), the calculating unit 152 selects the next setting content (step S204). Meanwhile, when there is no unselected setting content (No in step S203), the determining unit 153 determines the setting content with the highest prediction accuracy calculated by the calculating unit 152 as the setting content for the step selected by the selecting unit 151 (step S206).

When the setting content is selected, the calculating unit 152 calculates the prediction accuracy of the predicted model built on the basis of the pipeline to which the selected setting content has been applied (step S205). At the time, the calculating unit 152 can calculate the prediction accuracy by cross-validation using the learning data 20 divided into a predetermined number. Then, the calculating unit 152 repeats steps S203 to S205 until there is no longer unselected setting content.

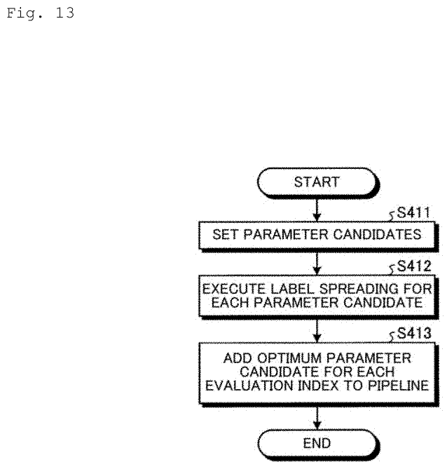

With reference to FIG. 12, how the analysis device 10 performs processing for determining a pipeline suitable for semi-supervised learning will be described. FIG. 12 is a flowchart for illustrating the flow of processing for determining a pipeline.

As shown in FIG. 12, the generating unit 154 first selects an unselected pipeline (step S401) and performs preprocessing to each piece of data according to the selected pipeline (step S402). When the algorithm of a prediction model corresponding to the pipeline is neighborhood search (Yes in step S403), the generating unit 154 performs label spreading (step S404). Meanwhile, when the algorithm of the prediction model corresponding to the pipeline is not neighborhood search (No in step S403), the generating unit 154 carries out self-training (step S405).

When there is an unselected pipeline (Yes in step S406), the generating unit 154 returns to step S401 and repeats the processing. When there is no unselected pipeline (No in step S406), the determining unit 153 determines the optimum pipeline for each evaluation index (step S407). Then, the validating unit 155 builds a prediction model using the determined pipeline (step S408).

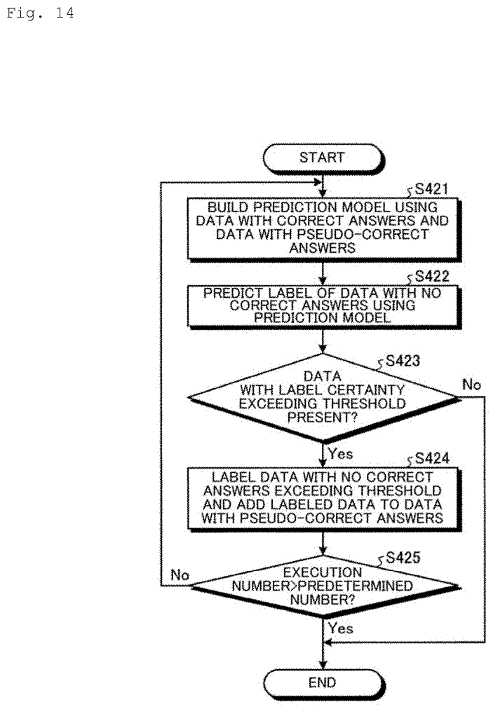

With reference to FIG. 13, the flow of label spreading will be described. FIG. 13 is a flowchart for illustrating the flow of label spreading. As shown in FIG. 13, the generating unit 154 first sets parameter candidates for neighborhood search (step S411).

Then, the generating unit 154 performs label spreading for each of the parameter candidates (step S412). More specifically, the generating unit 154 performs neighborhood search for each of the parameter candidates and labels data with no correct answers on the basis of data with correct answers. The generating unit 154 adds the optimum parameter candidate for each evaluation index to the pipeline (step S413).

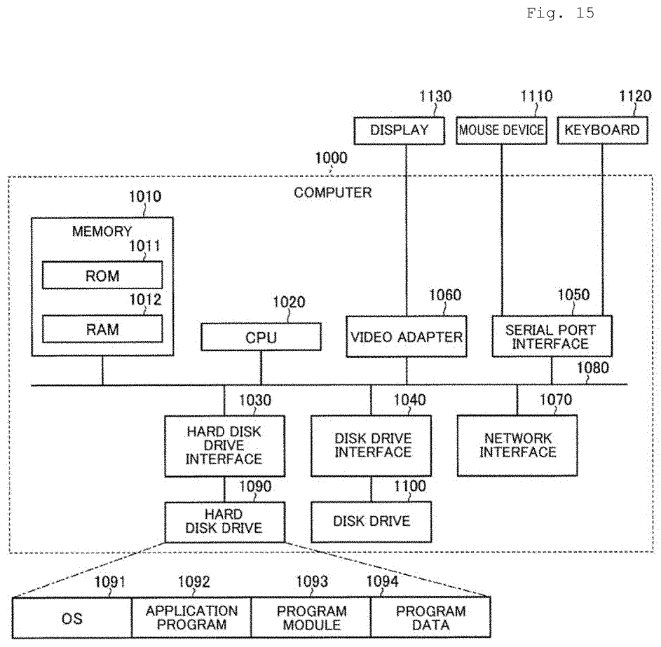

With reference to FIG. 14, the flow of self-training will be described. FIG. 14 is a flowchart for illustrating the flow of self-training. As shown in FIG. 14, the generating unit 154 builds a prediction model using data with correct answers and data with pseudo-correct answers (step S421). Note however that the data with pseudo-correct answers may not be generated at the start of processing.

Then, using a prediction model, the generating unit 154 predicts the label of the data with no correct answers (step S422). Here, when there is data having a predicted label certainty exceeding a threshold (Yes in step S423), the generating unit 154 labels the data with no correct answers exceeding the threshold and adds the data to the data with pseudo-correct answers (step S424).

Here, the execution number of steps from S421 to S424 does not exceed a predetermined number (No in step S425), the generating unit 154 returns to step S421 and repeats the processing. Meanwhile, when the execution number of steps from S421 to S424 exceeds the predetermined number (Yes in step S425), the generating unit 154 ends the label spreading processing. In the step S423, when there is no data having a predicted label certainty exceeding the threshold value (No in step S423) , the generating unit 154 ends the label spreading at the point.

### Effects of First Embodiment

The generating unit 154 generates data with pseudo-correct answers by labeling unlabeled data with no correct answers on the basis of labeled data with correct answers using each of the plurality of prediction models for predicting a label from data built according to building procedures different from one another. The calculating unit 152 calculates the prediction accuracy of each of the prediction models using data with correct answers and data with pseudo-correct answers. The determining unit 153 determines a prediction model for which the prediction accuracy calculated by the calculating unit 152 satisfies a predetermined criterion. In this way, according to the first embodiment, a pipeline is finally determined on the basis of a prediction accuracy when semi-supervised learning is performed for each of a plurality of pipelines (building procedures). Therefore, since semi-supervised learning uses both data with correct answers and data with no correct answers, data with no correct answers is effectively utilized to improve the accuracy of the prediction model according to the first embodiment.

When the prediction model performs neighborhood search, the generating unit 154 performs label spreading to data with no correct answers on the basis of data with correct answers by neighborhood search for which each of a plurality of parameter candidates is set. The calculating unit 152 calculates the prediction accuracy of the prediction model for each of the parameter candidates using the data with correct answers and the label-spread data with no correct answers. In this way, according to the first embodiment, optimum parameters for label spreading can be determined.

The generating unit 154 repeats the first processing for building a prediction model using building data including data with correct answers and the second processing for labeling data for which the certainty of a label predicted using the prediction model built in the first processing is at least equal to a threshold among data with no correct answers and then adding the labeled data to the building data. In this way, according to the first embodiment, among data with no correct answers, data having some high label certainty is selected and the accuracy of the prediction model can be improved.

The calculating unit 152 expresses the calculated prediction accuracy in a plurality of indices. The determining unit 153 determines a prediction model in which any of the plurality of indices becomes optimum among the building procedures. The index to be used for expressing the prediction accuracy of the prediction model may vary depending on the situation in which the analysis result of the data is used. Therefore, according to the first embodiment, a plurality of pipelines corresponding to various indices can be obtained, and various situations can be addressed.

[System Configuration, etc.]

The components of each illustrated device represent functional concepts and do not necessarily need to be physically configured as illustrated. More specifically, the specific forms of distribution and integration of the devices are not limited to those shown and the components can be in whole or in part functionally or physically distributed/integrated on an arbitrary unit basis depending on various loads or use conditions. In addition, the processing functions performed in the devices may be in whole or in part implemented by a CPU and a program analyzed and executed in the CPU or as hardware based on wired logic.

Also, the processing according to the embodiment described as being automatically executed may be in whole or in part performed manually, while the processing described as being performed manually may be in whole or in part performed automatically in a known manner. In addition, information including processing procedures, control procedures, specific names, various types of data and parameters in the above-description and drawings may be optionally modified unless otherwise specified.

[Program]

According to one embodiment, the analysis device 10 may be implemented by installing, on a desired computer, an analysis program to perform the above-described analysis as package software or on-line software. For example, when an information processing apparatus may be caused to execute the analysis program described above, the information processing apparatus can function as the analysis device 10. The information processing apparatus as used herein includes a desktop or notebook personal computer. Alternatively, the information processing apparatus includes a mobile communication terminal such as smartphone and a PHS (Personal Handyphone System) and a slate terminal such as a PDA (Personal Digital Assistant).

The analysis device 10 may also be implemented as an analysis server device which is used by a user terminal device as a client and provides the client with services related to the above-described analysis. For example, the analysis server device is implemented as a server device which provides an analysis service in which learning data is an input and a pipeline or a prediction model is an output. In this case, the analysis server device may be implemented as a web server or as a cloud which provides services related to the analysis by outsourcing.

FIG. 15 is a diagram of an exemplary computer which executes an analysis program. The computer 1000 has for example a memory 1010 and a CPU 1020. The computer 1000 also has for example a hard disk drive interface 1030, a disk drive interface 1040, a serial port interface 1050, a video adapter 1060, and a network interface 1070. These components are connected by a bus 1080.

The memory 1010 includes a ROM (Read Only Memory) 1011 and a RAM 1012. The ROM 1011 may store a boot program such as BIOS (Basic Input Output System). The hard disk drive interface 1030 is connected to a hard disk drive 1090. The disk drive interface 1040 is connected to a disk drive 1100. A removable storage medium such as a magnetic disk and an optical disk is inserted into the disk drive 1100. The serial port interface 1050 is connected for example to a mouse device 1110 and a keyboard 1120. The video adapter 1060 is connected for example to a display 1130.

The hard disk drive 1090 stores for example an OS 1091, an application program 1092, a program module 1093, and program data 1094. More specifically, the program defining the processing by the analysis device 10 is implemented as the program module 1093 which describes a code executable by the computer. The program module 1093 is stored, for example, in the hard disk drive 1090. For example, the program module 1093 for executing processing similar to the functional configuration of the analysis device 10 is stored in the hard disk drive 1090. The hard disk drive 1090 may be replaced by an SSD.

The setting data used in the processing according to the embodiment is stored as the program data 1094 for example in the memory 1010 or the hard disk drive 1090. The CPU 1020 reads and executes the program module 1093 or the program data 1094 stored in the memory 1010 or the hard disk drive 1090 into the RAM 1012 as needed.

The program module 1093 and the program data 1094 are not necessarily stored in the hard disk drive 1090 and may be stored in a removable storage medium and read out by the CPU 1020 through the disk drive 1100. Alternatively, the program module 1093 or the program data 1094 may be stored in another computer connected over a network (for example a LAN or a WAN (Wide Area network)). The program module 1093 and the program data 1094 may then be read out from the other computer by the CPU 1020 through the network interface 1070.

### REFERENCE SIGNS LIST

10 Analysis Device
11 Input unit
12 Output unit
13 Communication control unit
14 Storage unit
15 Control unit
141 Setting information
142 Predictor information
151 Selecting unit
152 Calculating unit
153 Determining unit
154 Generating unit
155 Validating unit

1. An analysis device, comprising: a memory; and a processor coupled to the memory and programmed to execute a process comprising:
generating data with a pseudo-correct answer by labeling unlabeled second data on the basis of labeled first data using a plurality of prediction models for predicting a label from data, the prediction models being built according to different building procedures from one another;
calculating a prediction accuracy for each of the prediction models using the first data and the data with the pseudo-correct answer; and
determining a prediction model with a prediction accuracy calculated by the calculating satisfying a prescribed criterion.

2. The analysis device according to claim 1, wherein when the prediction model is for performing neighborhood search, the generating performs label spreading to the second data on the basis of the first data by neighborhood search for which a plurality of parameter candidates are set, and the calculating calculates a prediction accuracy for the prediction model for each of the parameter candidates using the first data and the label-spread second data.

3. The analysis device according to claim 1, wherein the generating repeats first processing for building a prediction model using building data including the first data and second processing for labeling data with a label certainty predicted by the prediction model built in the first processing being at least equal to a threshold among the second data and then adding the labeled data to the building data.

4. The analysis device according to claim 1, wherein the calculating indicates the calculated prediction accuracy in a plurality of indices, and the determining determines a prediction model in which any one of the plurality of indices becomes optimum among the building procedures.

5. An analysis method executed by an analysis device, comprising the steps of:
generating data with a pseudo-correct answer by labeling unlabeled second data according to labeled first data using a plurality of prediction models for predicting a label from data, the prediction models being built according to different building procedures from one another;
calculating a prediction accuracy for each of the prediction models using the first data and the data with the pseudo-correct answer; and
determining a prediction model with a prediction accuracy calculated in the calculating step satisfying a prescribed criterion.

6. (canceled)

7. A non-transitory computer-readable recording medium having stored therein a program, for analysis, that causes a computer to execute a process comprising:
generating data with a pseudo-correct answer by labeling unlabeled second data on the basis of labeled first data using a plurality of prediction models for predicting a label from data, the prediction models being built according to different building procedures from one another;
calculating a prediction accuracy for each of the prediction models using the first data and the data with the pseudo-correct answer; and
determining a prediction model with a prediction accuracy calculated by the calculating satisfying a prescribed criterion.
